(19) United States
(12) Patent Application Publication
(10) Pub. No.: US 2012/0098374 A1
(43) Pub. Date: Apr. 26, 2012

(54) VARIABLE-SPEED MAGNETIC COUPLING AND METHOD FOR CONTROL

(76) Inventors: Alvaro Jorge Mari Curbelo, Unterschleissheim (DE); Stefan Brandhoff, Garching b. Munchen (DE); Robert J. Ciszak, Fairview, PA (US); Johannes Huber, Garching b. Munchen (DE); Jan E. Hemmelmann, Muenchen (DE); Michal-Wolfgang Waszak, Muenchen (DE)

(21) Appl. No.: 12/911,284

(22) Filed: Oct. 25, 2010

(51) Int. Cl. H02K 49/06

(52) U.S. Cl. 310/103

(57) ABSTRACT

An apparatus includes a first rotor operatively connected to an output shaft and holding a first array of pole pieces; a second rotor operatively connected to an input shaft coaxially with the first rotor and holding a second array of pole pieces; and an array of field windings disposed coaxially with the first and second rotors. The array of field windings being arranged to interact magnetically with a harmonic frequency of the magnetic field of the first or second array of pole pieces in a magnetically geared manner and being selectively energizable to control electromagnetic coupling of the first array of pole pieces with the second array of pole pieces, and thereby to transfer at least one of torque and speed from the input shaft to the output shaft.

### FIELD OF THE INVENTION

Embodiments of the invention relate to variable-speed magnetic couplings and control methods and more particularly to drive trains incorporating electromagnetic couplings.

### BACKGROUND OF THE INVENTION

Renewable forms of energy, such as wind power, have become increasingly desirable sources for meeting present and future electrical power requirements. Wind power typically is harvested through the use of a turbine having a rotor head with blades and a rotatable shaft coupled to the head. The rotatable shaft is connected, either directly or indirectly, to a generator. Key challenges in harvesting wind energy for power generation include reliability and noise quality of the wind source, i.e., accounting for variations in the angular velocity of the rotatable shaft caused by variations in wind speed.

As will be appreciated, generators driven by wind turbines typically include an apparatus for smoothing or filtering variations in the wind input to the turbine, such that at the terminals to the electrical grid a constant frequency electrical power is delivered. In particular, several types of apparatus are used to filter wind turbine noise. For example, a purely electronic apparatus such as a power converter connected between turbine generator output leads and an electrical grid connector may be employed. Digitally switched power converters, however, may be expensive for full power conversion and are relatively complex. As another example, doubly-fed induction machines can be deployed as a generator in order to produce constant frequency output power. For doubly-fed induction machines, typically about 30% of the nominal power needs to be converted by digitally switched power converters.

Moreover, mechanical apparatus connected between the turbine and the generator may also be employed. These include hydrodynamic or hydrostatic torque converters, as well as continuously or infinitely variable transmissions such as, for example, friction disc or belt transmissions. While potentially effective, mechanical torque converters or transmissions present a tradeoff between variability of speed/torque ratio and efficiency of torque conversion. In particular, mechanical designs permitting large variations of ratio also tend to be relatively inefficient.

In view of the above, a need exists for relatively simple apparatus that will efficiently and reliably filter mechanical noise, across a varying range of speeds, to provide a reliable electrical output from a wind turbine generator.

### BRIEF DESCRIPTION OF THE INVENTION

In one embodiment of the invention, an apparatus includes a first rotor operatively connected to an output shaft and holding a first array of pole pieces; a second rotor operatively connected to an input shaft coaxially with the first rotor and holding a second array of pole pieces; and an array of field windings disposed coaxially with the first and second rotors, the array of field windings being arranged to interact magnetically with a harmonic frequency of a magnetic field of the first or second array of pole pieces in a magnetically geared manner and being selectively energizable to control electromagnetic coupling of the first array of pole pieces with the second array of pole pieces and thereby transfer at least one of torque and speed from the input shaft to the output shaft.

In another embodiment of the invention, a wind turbine gearbox includes an apparatus for variable transfer of torque and speed. The apparatus has a first rotor connected to an output shaft and holding a first array of pole pieces; a second rotor connected to an input shaft coaxial with the first rotor and holding a second array of pole pieces. The apparatus also includes a plurality of field windings coaxial with the first and second rotors, and a converter connected to energize the field windings with multi-phase alternating current. The converter is controlled to provide via the field windings an electromagnetic field rotating at a desired field velocity according to a function of at least a measured input velocity and a desired output velocity and to vary the multi-phase current in the field windings to vary torque transferred from the input shaft to the output shaft via electromagnetic coupling of the first and second annular arrays of pole pieces.

In another embodiment of the invention, a method for transmitting torque to an output shaft operatively connected to a first array of pole pieces from an input shaft operatively connected to a second array of pole pieces includes selectively energizing a field winding to magnetically engage the first array of pole pieces. The method also includes transmitting torque magnetically from the input shaft through the field winding to the output shaft, and controlling the field winding so that the output shaft has an output parameter within a determined range.

### BRIEF DESCRIPTION OF THE DRAWINGS

The present invention will be better understood from reading the following description of non-limiting embodiments, with reference to the attached drawings, wherein below:

FIG. 1 shows a schematic diagram of a wind turbine system including a variable speed magnetic coupling according to an embodiment of the present invention.

FIG. 2 shows an axial section of a mechanical structure of the variable speed magnetic coupling shown in FIG. 1.

FIG. 3 shows a radial section, at line 3-3, of the variable speed magnetic coupling shown in FIG. 2.

FIG. 4 shows a schematic of a control scheme for the variable speed magnetic coupling shown in FIGS. 1 through 3.

FIG. 5 shows a control flow schematic of an algorithm implemented via the control scheme shown in FIG. 4.

FIG. 6 shows an illustrative power flow graph for an embodiment of the variable speed magnetic coupling, control scheme, and algorithm shown in FIGS. 1 through 5.

FIG. 7 shows an axial section of an alternative mechanical structure of a variable speed magnetic coupling similar to that shown in FIGS. 1 through 3.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts.

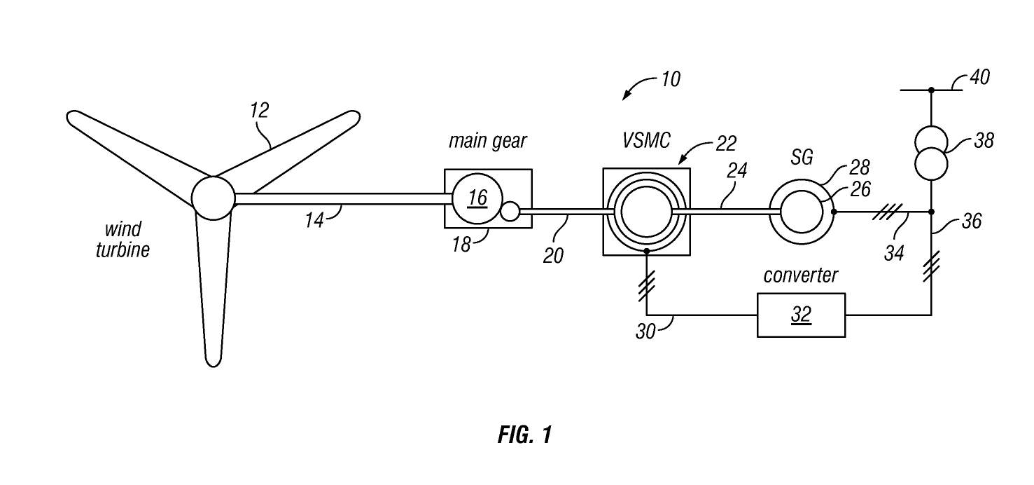

Referring to FIG. 1, the operational components of a wind turbine 10 include a turbine rotor or sail 12 mounted to one end of an input shaft 14. The other end of the input shaft 14 drives a bull or main gear 16 of a drive train 18. The drive train 18 drives an intermediary shaft 20, which is in turn connected to a variable speed magnetic coupling (VSMC) 22, in accordance with an embodiment of the present invention.

The VSMC 22 drives an output shaft 24, which turns a rotor 26 of an electrical generator 28. In certain embodiments of the invention, the electrical generator is a multiphase generator. As will be appreciated, however, a direct-current generator or single-phase generator also can be used with appropriate downstream power control electronics.

As shown, the VSMC 22 also includes multiphase leads 30 connected to a converter 32. The converter 32 is capable both for providing multiphase current to the VSMC 22 and for receiving multiphase current from the VSMC 22. Both the electrical generator 28 and the converter 32 are connected via multiphase leads 34 and 36, respectively, to a fused power supply 38, which transfers electrical power to and from an external electrical grid or transmission network 40. The fused power supply or grid connection 38 can include a “step up” transformer or other inductive device.

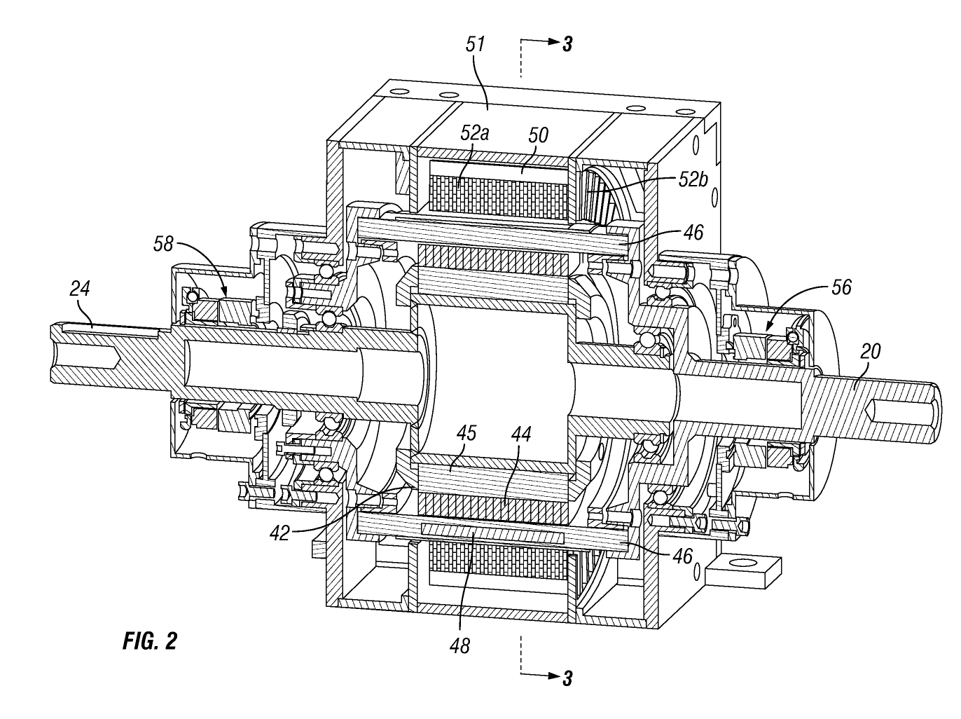

Referring to FIGS. 2 and 3, an embodiment of the VSMC 22 includes a first rotor 42 that is mounted to the output shaft 24. The first rotor supports a first array of permanent magnet pole pieces 44, which are evenly spaced about the first rotor. The first rotor also can include substantial “back iron” 45 supporting the pole pieces 44, as best shown in FIG. 2. The VSMC 22 also includes a second rotor 46 that is mounted to the intermediary shaft 20. The second rotor 46 supports and houses an evenly-spaced circumferential array of ferromagnetic pole pieces 48, as best shown in FIG. 3 (a radial section taken at line 3-3 in FIG. 2). In embodiments of the variable speed magnetic coupling, the second rotor 46 is fabricated substantially from a magnetically and electrically passive material, with sintered or laminated iron pole pieces 48 housed within or fastened to the passive material. For example, the rotor 46 may be fabricated from glass fiber wrapped in stages, such that the pole pieces 48 may be placed within open hollows of the rotor partway through the fiber layup process. Outer layers of glass fiber then may be wrapped over the pole pieces 48 to complete the rotor 46. The first array of pole pieces 44 and the second array of pole pieces 48 are annular arrays disposed coaxially, and in some embodiments the arrays may also be concentric.

The VSMC 22 also includes a stator ring 50 to which are mounted an annular array of field windings 52. The stator ring 50 is fixed to and supported by a back iron 51. The various phases of the field windings 52a, 52b, and 52c are electrically connected to the converter 32 via the multiphase leads 30. According to embodiments of the present invention, the array of field windings 52 embodies a number of magnetic pole pairs such that the field windings couple with a harmonic frequency of the first plurality of pole pieces 44. The field windings 52 can be energized by the converter 32 to provide a rotating electromagnetic field with a variable number of poles and phases. Alternatively the field windings 52 can energize the converter 32 to provide multiphase power to the electrical grid connection.

In embodiments of the VSMC 22, either of the first and second arrays of pole pieces 44, 48 provide magnetic field so that torque is transferable between the first rotor 42, the second rotor 46, and the field windings 52 via magnetic coupling. In operation of the VSMC 22, the first and second arrays of pole pieces 44, 48 remain magnetically coupled so long as the intermediary and output shafts 20, 24 rotate within “non-slip” ranges of speed and torque. Outside the non-slip ranges of speed and torque, the electromagnetic coupling forces between the pole pieces 44, 48 are overcome and the first rotor 42 is free to “slip” relative to the second ring 46, thus preventing adverse conditions in apparatus connected to the output shaft 24. For example, slippage of the VSMC 22 can prevent overvoltage or overcurrent conditions in stator windings of the generator 28.

In the illustrated embodiment of FIG. 3, the first rotor 42 houses eight (8) permanent magnet pole pieces 44, which form four (4) pole-pairs pS arranged to produce a spatially varying “sun” magnetic field. The field windings 52 of the stator 50 comprise nine (9) pole pairs pR to produce a spatially varying “ring” magnetic field. As will be appreciated, in other embodiments of the invention, the number of pole pairs of first rotor 42 and stator 50 may vary.

Given the number pS of permanent magnet pole pieces 44 and pR of poles formed by the stator windings 52, the appropriate number pC of modulating pole pieces 48 can be determined according to the formula pC=pS+pR, such that the pole pieces 48 modulate the magnetic field of the permanent magnets 44 to result in an asynchronous harmonic field component having the same number of poles as the field windings 52. In the example embodiment of FIG. 3, the number of modulating pole pieces is thirteen (13).

In use, the ferromagnetic pole pieces 48 of the second rotor 46 interact with both the “sun” field produced by the permanent magnets 44 and the “ring” field produced by the stator windings 52. In particular, the pole pieces 48 modulate the magnetic fields of the permanent magnets 44 and the field windings 52 so they interact to the extent that rotation of one rotor 42 or 46 will induce rotation of the other rotor 46 or 42 and of the stator field, in a “magnetically geared manner.” That is, for example, in case that the stator field frequency is zero or non-rotating, and that the first and second arrays of pole pieces 44, 48 are coupled in a non-slip condition, rotation of the first rotor 42 at a speed nS will induce rotation of the second rotor 46 at a speed nC where nCpC=nSpS.

As will be appreciated, design parameters of the variable speed magnetic coupling 22 thus include, but are not limited to, the number and arrangement of the pole pieces 48, the number of permanent magnets 44, and the number of poles produced by the stator field windings 52, to achieve the necessary magnetic circuit or coupling such that gearing results between the first rotor 42, the second rotor 46, and the field windings 52. For example, in one embodiment, the variable speed magnetic coupling may be designed, including control of the field windings 52, such that the rotating stator field acts like a movable ring gear of a planetary gear set, providing a speed superimposition to both the intermediary shaft 20 and the output shaft 24. Alternatively the field windings 52 can act equivalent to a regenerative brake slowing either or both the intermediary shaft 20 and output shaft 24. The converter 32 can be adjusted to control power split and power flow directions among the intermediary shaft 20, the output shaft 24, the field windings 52, the converter 32, and the grid connection 38.

Thus, according to embodiments of the present invention, the rotating electromagnetic field provided by the field windings 52 modulates the electromagnetic coupling between the first and second arrays of pole pieces 44, 48, such that the first array of magnetic pole pieces may rotate at an input angular velocity while the second array of magnetic pole pieces rotates at an output angular velocity different from the input angular velocity.

In particular, a flow of electrical power to or from the field windings 44 may be controlled such that an output velocity is maintained within a tolerance from a substantially constant value while an input velocity varies within an operational range. For example, the output angular velocity may be maintained at about fifteen hundred (1500) rpm while the input angular velocity of the intermediary shaft varies between one hundred (100) and four hundred (400) rpm. Accounting for the drive train 18 shown in FIG. 1, the output shaft 24 can be kept rotating at about fifteen hundred (1500) rpm while the input velocity of the main shaft 14 varies in speed between five (5) and twenty (20) rpm. In selected embodiments of the invention, the main shaft may vary in speed between ten (10) and eighteen (18) rpm while the output shaft is kept rotating at about fifteen hundred (1500) rpm. For purposes of this paragraph, “about” is considered to include values that are acceptable in view of relevant system parameters that will be apparent to those of ordinary skill. Such system parameters may vary according to design choices external to the VSMC 22. In another aspect, it is believed that rpm ranges “within a tolerance of” the aforementioned ranges would be optimal as indicated; “within a tolerance” is considered to include within +/−5%.

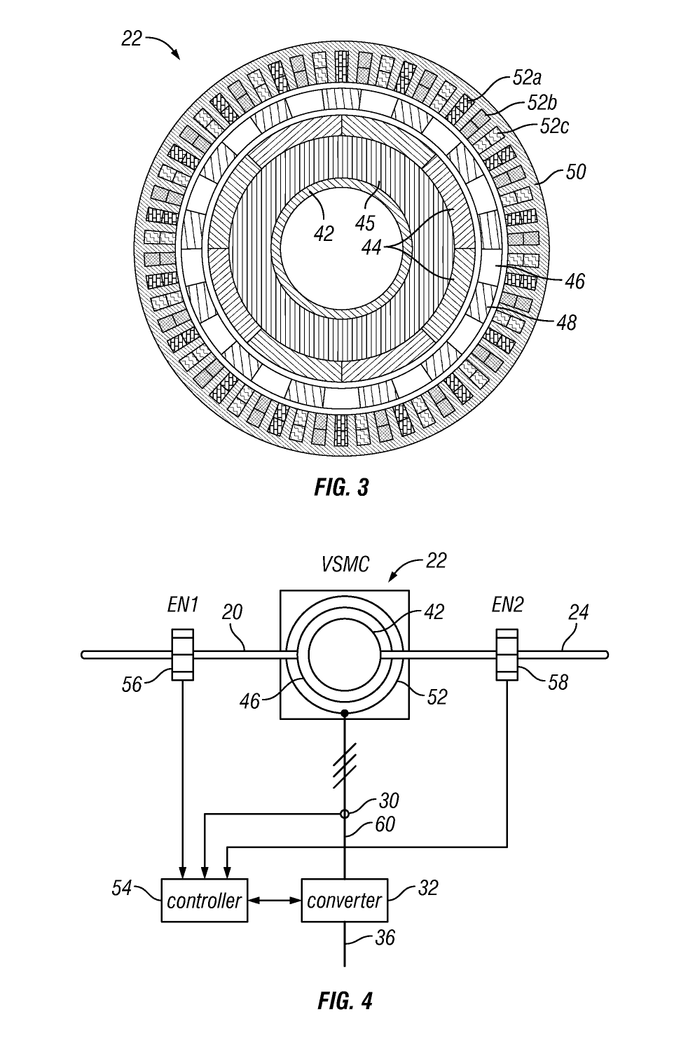

Referring now to FIG. 4, the converter 32 is capable to supply and to receive multiphase electrical power to and from the field windings 44 of the VSMC 22. As will be understood, the converter typically will be implemented in digital switching circuitry controlling semiconductors or arrays of semiconductors configured for high power and low latency. The converter may be implemented in hardware and/or software according to the typical skill. Various commercial converters may be adapted for connection to the field windings, and may be operated to provide via the field windings a rotating electromagnetic field (“stator field”) within the VSMC 22, thereby superimposing a rotational speed to the first and second arrays of pole pieces 52, 48 according to the inherent magnetic gear ratio between field windings and the first and second array of pole pieces respectively mounted to the first and second rotor 53, 46. Thus, the VSMC 22 can be controlled, via the converter 32, to adjust a ratio or differential between the input angular velocity of the intermediary shaft 20 and the output angular velocity of the output shaft 24.

According to embodiments of the present invention, the converter 32 is controlled by a controller 54 based on various measured system variables and pre-set target parameters. For example, a first velocity sensor 56 may be operatively connected to the intermediary shaft 20 and to the controller 54. A second velocity sensor 58 may be operatively connected to the output shaft 24 and to the controller 54. Electrical sensors 60 may be connected to the multiphase leads 30 and to the controller 54.

In selected embodiments, the controller 54 can be configured to measure at least the input angular velocity of the intermediary shaft 20 (via the input tachometer or position encoder 56) and the output angular velocity of the output shaft 24 (via the output tachometer or position encoder 58), as well as measuring phase current and/or voltage on one or more of the multiphase leads 30 via electrical sensors 60. By way of non-limiting examples, the input and output tachometers or velocity sensors may be implemented as optical position encoders, eddy current devices, reflective tachometers, or any other velocity measurement devices. The electrical sensors may include resistive or inductive ammeters or voltmeters implemented in analog or digital circuitry with appropriate connections and protection.

The controller 54 may, by way of non-limiting example, be configured to control the converter 32 to provide via the field windings 44 of the VSMC 22 an electromagnetic field (stator field) rotating at a desired field velocity nR according to a function of at least the input angular velocity of the first ring (as measured via the tachometer or position encoder 56) and the desired output angular velocity of the second ring. For example, the desired field velocity nR may be controlled according to a function

nR=(nS−nC(1−i0))/i0,

where nC is the input angular velocity of the second rotor 46, nS is the output angular velocity of the first rotor 44, and i0 is an equivalent gearing ratio determined in analogy to the basic gear ratio of planetary or epicyclic gearings to be i0=pS/pR=nR/nS with pS being the number of permanent magnet pole pairs of first rotor pole pieces 44, and pR being the number of pole pairs of stator field windings 52.

An advantage that may be realized in the practice of some embodiments of the variable speed magnetic coupling is that the coupling requires only about 10% of the nominal turbine rotor power to be converted by the digitally switched converter in order to achieve the same speed variability as can be attained by a doubly-fed induction machine. In particularly advantageous embodiments, a gear ratio (i0=(pS/pR)) is chosen to be greater than one, that is, the pole pairs of stator field windings pS are greater than the pole pairs of output rotor pR, such that the stator field windings require minimal electrical power for adjustment of input and output rotor speeds.

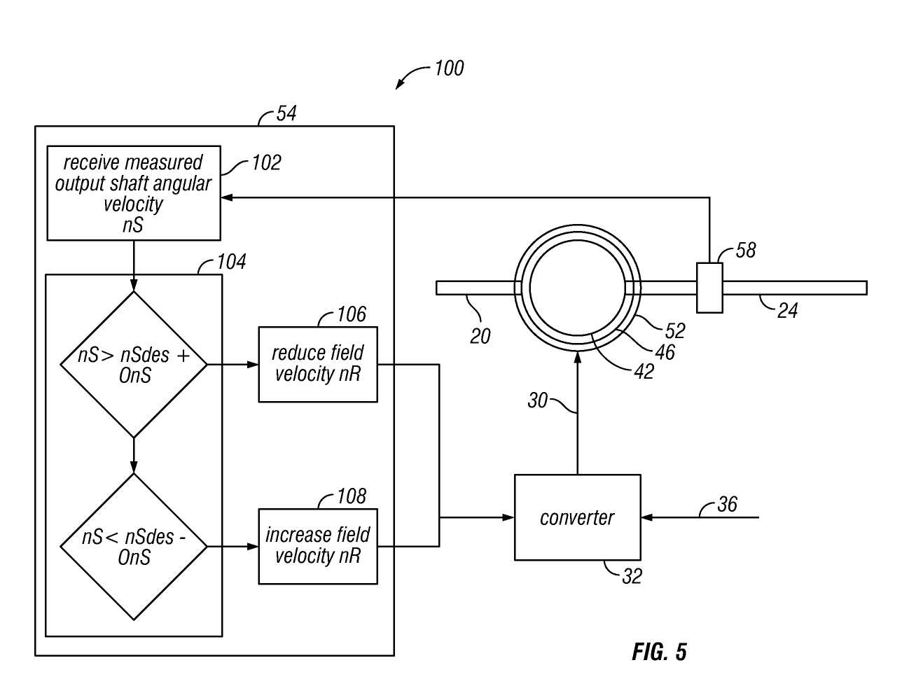

Referring now to FIG. 5, embodiments of the invention can include a method 100 for controlling field windings of a variable speed magnetic coupling so as to maintain an output shaft angular velocity nS within a desired operating range. For example, field windings may be energized in staggered overlapping sequence (multiphase energization) to produce a rotating magnetic field with angular velocity nR. The field velocity nR may be controlled according to various functions, including, but not limited to:

nC*(1−i0)=nS−i0*nR; and

−OnS<nS−nSdes<OnS.

In the above exemplary control functions, OnS is a control range parameter setting upper and lower thresholds for nS (output shaft angular velocity) such that when a threshold is exceeded, then field winding energization will be adjusted so as to increase or reduce the field velocity nR.

For example, at a step 102, the controller 54 may receive from the optical encoder 58 for the output shaft 24 a signal indicating output shaft angular velocity nS. At a step 104, the controller compares nS to the pre-determined optimal value nSdes. If nS>nSdes+OnS, then at a step 106, the controller 54 adjusts operation of the converter 32 to energize the field windings 52 for a slower field velocity nR. However, if nS<nSdes−OnS, then at a step 108, the controller 54 adjusts the converter 32 to energize the field windings 52 for a faster field velocity nR. Various modes of adjusting the converter 32 will be apparent without undue experimentation.

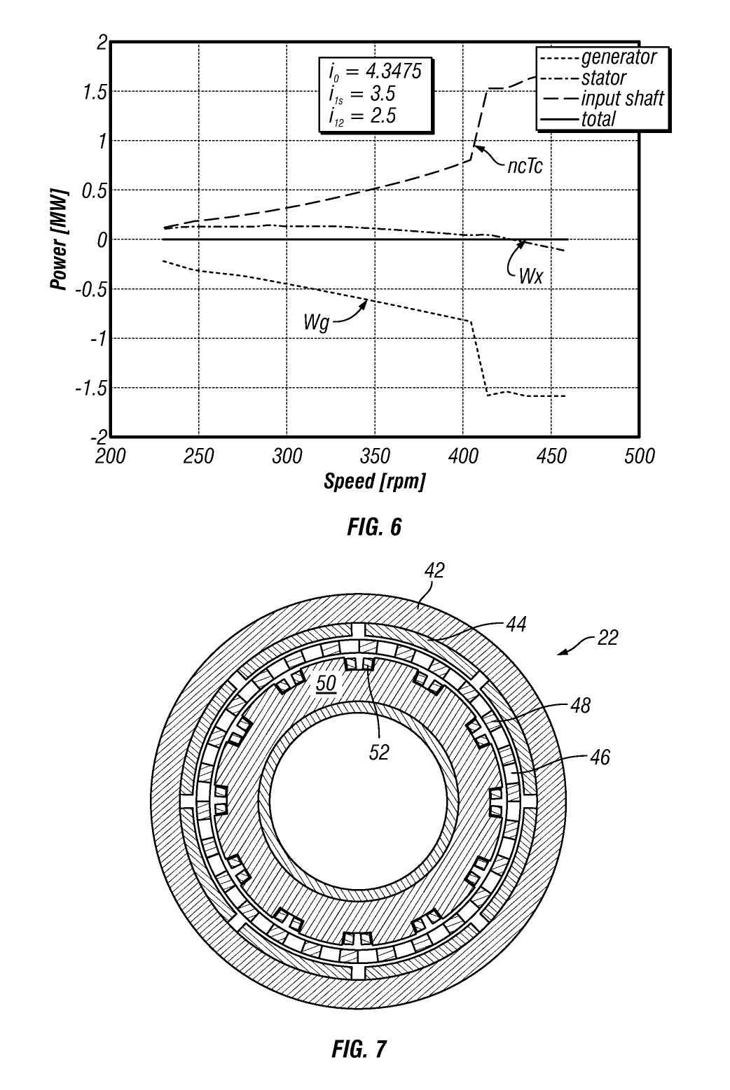

For example, referring to FIG. 6, a power flow Wx between the converter 32 and the stator field windings 52 may be adjusted so as to maintain output shaft velocity nS substantially constant at fifteen hundred (1500) rpm throughout an input velocity range of about two hundred twenty (220) up to about four hundred sixty (460) rpm. Under the conditions illustrated in FIG. 6, it is expected that operation of the variable speed magnetic coupling 22 may result in a varying relation between power Wg provided from the generator 28 and power ncTc received at the input shaft rotor 46, substantially as shown.

Referring to FIG. 7, in an additional alternative embodiment of the inventive variable speed magnetic coupling 22, the stator 50 and field windings 52 may be centrally located within the hollow rotating rotor 46 mounted to an input shaft 20 (not shown), while the first rotor 42 may be disposed at the periphery of the VSMC 22.

In use, an embodiment of the invention may include a wind turbine blade assembly, a main shaft carrying the turbine blade assembly, an intermediary shaft, a main gear operatively connecting the intermediary shaft to the main shaft at a speed ratio, a variable-speed magnetic coupling or planetary electromagnetic gear driven by the intermediary shaft, an output shaft driven by the variable-speed planetary electromagnetic gear, an electrical generator driven by the output shaft, a converter electrically connected to the variable-speed magnetic coupling, and a controller electrically connected to the converter. In certain circumstances, one or more of the turbine blade assembly, the main shaft, and the main gear may be omitted from this embodiment. The inventive apparatus may be controlled according to a method including steps of measuring a shaft velocity or an electrical parameter and controlling a field winding of the variable-speed magnetic coupling according to the measured velocity or electrical parameter. It will readily be appreciated that the terms “input” and “output” are substantially interchangeable descriptions of the exemplary structural layout, and that the variable speed magnetic coupling could equally well be used to keep input velocity constant while output velocity varies.

In other embodiments, the inventive apparatus may also include speed, torque, current, or voltage sensors, electrical interconnections or leads, and/or an electrical grid connection. Moreover, if included, the electrical grid connection may further include fusible links, step-up transformers, and/or digital current converters.

Selected embodiments of the invention may include a first rotor operatively connected to an output shaft and holding a first array of pole pieces, a second rotor operatively connected to an input shaft coaxially with the first rotor and holding a second array of pole pieces, and an array of field windings disposed coaxially with the first and second rotors. The first array of pole pieces may include permanent magnet pole pieces and the second array of pole pieces may include ferromagnetic pole pieces. The array of field windings may be arranged to interact magnetically with a harmonic frequency of the magnetic field of the first or second array of pole pieces in a magnetically geared manner, and may be selectively energizable to control electromagnetic coupling of the first array of pole pieces with the second array of pole pieces, and thereby to transfer at least one of torque and speed from the input shaft to the output shaft. The first and second arrays of pole pieces and the array of field windings may be concentric annular arrays. The array of field windings may be selectively energized to maintain the output shaft at a substantially constant output velocity while the input shaft moves within an operational range of input velocity. For example, the array of field windings may be selectively energized with multi-phase alternating current provided from a converter. In some embodiments the substantially constant output velocity may be about fifteen hundred (1500) revolutions per minute, while the operational range of input velocity may be between about one hundred (100) and about four hundred (400) revolutions per minute. The apparatus may further include a velocity sensor operatively connected to one of the first rotor or the second rotor, the converter being controlled according to at least a signal from the velocity sensor. The converter may further be controlled according to at least a measured output velocity of the second rotor, a measured input velocity of the first rotor, and/or a desired output velocity of the second rotor. For example, the converter may be controlled to provide via the field windings an electromagnetic field rotating at a desired field velocity nR according to a function of at least the measured input velocity nC of the first rotor and the desired output velocity nS of the second rotor. The function may be of the form nR=(nS−nC(1−i0))/i0, where i0 is an equivalent gearing ratio determined according to at least the number of magnetic pole pieces in the first annular array and the number of magnetic pole pieces in the second annular array.

Another embodiment relates to apparatus comprising a first rotor, a second rotor, and an array of field windings. The first rotor is operatively connected to an output shaft and holds a first array of pole pieces (e.g., magnetic pole pieces). The second rotor is operatively connected to an input shaft coaxially with the first rotor and holds a second array of pole pieces (e.g., magnetic pole pieces). The array of field windings is disposed coaxially with the first and second rotors. The array of field windings is arranged to interact magnetically with a harmonic frequency of a magnetic field of the first or second array of pole pieces in a magnetically geared manner, and is selectively energizable to control electromagnetic coupling of the first array of pole pieces with the second array of pole pieces, and thereby to transfer at least one of torque and speed from the input shaft to the output shaft. The array of field windings is selectively energized to maintain the output shaft at about a constant output velocity while the input shaft moves within an operational range of input velocity. “About a constant output velocity” means an output velocity that is constant within +−0.5%, said range being due to, for example, part tolerances, and inconsequential to operation according to the stated functionality.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of ordinary skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person of ordinary skill in the art to practice the embodiments of invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described variable speed magnetic coupling, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An apparatus, comprising:
a first rotor operatively connected to an output shaft and holding a first array of pole pieces;
a second rotor operatively connected to an input shaft coaxially with the first rotor and holding a second array of pole pieces; and
an array of field windings disposed coaxially with the first and second rotors, the array of field windings being arranged to interact magnetically with a harmonic frequency of a magnetic field of the first or second array of pole pieces in a magnetically geared manner and being selectively energizable to control electromagnetic coupling of the first array of pole pieces with the second array of pole pieces, and thereby to transfer at least one of torque and speed from the input shaft to the output shaft.

2. The apparatus as claimed in claim 1, wherein the first and second arrays of pole pieces and the array of field windings are concentric annular arrays.

3. The apparatus as claimed in claim 1, wherein the array of field windings is selectively energized to maintain the output shaft at a substantially constant output velocity while the input shaft moves within an operational range of input velocity.

4. The apparatus as claimed in claim 3, wherein the operational range of input velocity is between about five and about fifteen rotations per minute.

5. The apparatus as claimed in claim 3, wherein the operational range of input velocity is between about fifteen and about twenty rotations per minute.

6. The apparatus as claimed in claim 3, wherein the substantially constant output velocity is about fifteen hundred revolutions per minute while the operational range of input velocity is between about one hundred and about four hundred revolutions per minute.

7. The apparatus as claimed in claim 1, wherein the array of field windings is selectively energized with multi-phase alternating current provided from a converter.

8. The apparatus as claimed in claim 7, wherein the first array of pole pieces includes permanent magnet pole pieces and the second array of pole pieces includes ferromagnetic pole pieces.

9. The apparatus as claimed in claim 7, the converter being controlled according to at least a measured output velocity of the second rotor.

10. The apparatus as claimed in claim 7, the converter being controlled according to at least measured input velocity and desired output velocity of the first rotor and the second rotor, respectively.

11. The apparatus as claimed in claim 7, further comprising a velocity sensor operatively connected to one of the first rotor or the second rotor, the converter being controlled according to at least a signal from the velocity sensor.

12. The apparatus as claimed in claim 7, the converter being controlled to provide via the field windings an electromagnetic field rotating at a desired field velocity nR according to a function of at least the measured input velocity nC of the first rotor and the desired output velocity nS of the second rotor.

13. The apparatus as claimed in claim 12, wherein the desired field velocity nR=(nS−nC(1−i0))/i0, and i0 is an equivalent gearing ratio determined according to at least the number of pole pieces in the first array and the number of pole pieces in the second array.

14. The apparatus as claimed in claim 13, wherein i0 is about 2.25.

15. The apparatus as claimed in claim 1, wherein the array of field windings is selectively energized with multi-phase alternating current provided from a converter, the converter being controlled to change the multi-phase current so as to transfer a pre-determined torque amount from the first rotor to the second rotor via electromagnetic coupling of the first and second arrays of pole pieces.

16. A wind turbine gearbox including an apparatus for variable transfer of torque and speed, the apparatus comprising:
a first rotor connected to an output shaft and holding a first array of pole pieces;
a second rotor connected to an input shaft coaxial with the first rotor and holding a second array of pole pieces;
a plurality of field windings coaxial with the first and second rotors; and
a converter connected to energize the field windings with multi-phase alternating current, the converter being controlled to provide via the field windings an electromagnetic field rotating at a desired field velocity according to a function of at least a measured input velocity and a desired output velocity, and further being controlled to vary the multi-phase current so as to vary torque transferred from the input shaft to the output shaft via electromagnetic coupling of the first and second annular arrays of pole pieces.

17. A method for transmitting torque to an output shaft operatively connected to a first array of pole pieces from an input shaft operatively connected to a second array of pole pieces, comprising:
selectively energizing a field winding to magnetically engage the first array of pole pieces;
transmitting torque magnetically from the input shaft to the output shaft; and
controlling the field winding so that the output shaft has an output parameter within a determined range.

18. The method as claimed in claim 17, wherein the output parameter is torque, speed, or power.

19. The method as claimed in claim 17, wherein controlling the field winding includes:
measuring a velocity of the input shaft; and
energizing the field winding to increase or reduce magnetic torque transfer from the input shaft to the output shaft, based on the measured velocity of the input shaft to maintain a parameter of the output shaft.

20. The method as claimed in claim 17, wherein controlling the field winding includes:
measuring a velocity of the output shaft; and
energizing the field winding to increase or reduce magnetic torque transfer from the input shaft to the output shaft to maintain the measured velocity of the output shaft within an output velocity range.

21. The method as claimed in claim 17, wherein controlling the field winding includes:
sensing a generator parameter; and
energizing the field winding to increase or reduce magnetic torque transfer from the input shaft to the output shaft to prevent the generator parameter exceeding an operating range.

22. The method as claimed in claim 17, wherein controlling the field winding includes:
selecting a desired output velocity of the output shaft;
measuring an input velocity of the input shaft; and
energizing the field winding according to a function of at least the measured input velocity and the desired output velocity.

23. The method as claimed in claim 22, wherein the function is of the form nS−i0*nR=nC(1−i0), nC being the measured input velocity, nS being the desired output velocity, i0 being an equivalent magnetic gear ratio, and nR being a velocity of an electromagnetic field produced by the annular array of field windings, a converter being controlled to adjust nR according to nS and nC.

24. The method as claimed in claim 23, wherein i0 is about 2.25.

25. The method as claimed in claim 22, wherein the function incorporates a measured value of at least one of a field winding phase voltage, a field winding phase current, and a torque transferred from the input shaft to the output shaft.
